(19) United States
(12) Patent Application Publication
(10) Pub. No.: US 2023/0080841 A1
(43) Pub. Date: Mar. 16, 2023

(54) DRIVE LETTER BINDING SYSTEM AND METHOD THEREOF

(71) Applicants: SQ TECHNOLOGY (SHANGHAI) CORPORATION, Shanghai (CN); INVENTEC CORPORATION, Taipei City (TW)

(72) Inventor: Weiguo ZHAO, Shanghai (CN)

(21) Appl. No.: 17/697,427

(22) Filed: Mar. 17, 2022

(30) Foreign Application Priority Data
Sep. 13, 2021 (CN) 202111070687.2.

(51) Int. Cl. G06F 3/06

(52) U.S. Cl. CPC G06F 3/0635; G06F 3/0604; G06F 3/0676

(57) ABSTRACT

A drive letter binding system is disclosed, which is for binding hard disk drives to their respective corresponding drive letters and includes a reading module, a binding module and an execution module. The reading module is used to, after an operating system of a host identifies the hard disk drives and their respective corresponding drive letters, read both the drive letters and hard disk drive identification paths corresponding to the respective hard disk drives. The binding module is used to bind the hard disk drives to their corresponding drive letters using the hard disk drive identification paths and generate binding information. The execution module is used to, in the event of any hard disk drive being electrically reconnected to the host or the operating system being restarted, utilize the binding information to enable the operating system to identify the drive letters to which the respective hard disk drives are bound.

### CROSS-REFERENCES TO RELATED APPLICATION

This application claims the priority of Chinese patent application number 202111070687.2, filed on Sep. 13, 2021, the entire contents of which are incorporated herein by reference.

### TECHNICAL FIELD

The present invention relates to a system and a method thereof and, in particular, to drive letter binding system and a method thereof.

### BACKGROUND

Generally, when a hard disk drive is electrically connected to a host, an operating system of the host will identify the hard disk drive and produce a corresponding drive letter for the hard disk drive. Reference is now made to FIG. 1, a flowchart describing the operating system's identification of the hard disk drive according to a prior-art method. This prior-art identification method includes steps S901 to S903.

In step S901, the hard disk drive is electrically connected to the host. In step S902, the hard disk drive is identified by the operating system of the host. In step S903, following the identification of the hard disk drive, the operating system generates the corresponding drive letter. In case of a plurality of hard disk drives to be electrically connected to the host, the operating system will generate drive letters for them in the order where the hard disk drives are identified, rather than in the order of their electrical connection to the host.

Reference can be made to Tables 1 and 2 below. Table 1 shows the order of electrical connection of the hard disk drives to the host, and Table 2 presents the drive letters generated by the operating system.

TABLE 1

| | | | |
|---|---|---|---|
| HDD0 | HDD3 | HDD6 | HDD9 |
| HDD1 | HDD4 | HDD7 | HDD10 |
| HDD2 | HDD5 | HDD8 | HDD11 |

TABLE 2

| | | | |
|---|---|---|---|
| sda | sde | sdg | Sdk |
| sdc | sdf | sdh | Sdj |
| sdb | sdd | sdi | sdl |

The operating system first identifies the hard disk drive HDD0 that is first electrically connected to the host, and generates sda as its corresponding drive letter. Despite the fact that the hard disk drive HDD1 is electrically connected to the host earlier than the hard disk drive HDD2, since the operating system identifies first the hard disk drive HDD2 and then the hard disk drive HDD1, the generation of the corresponding drive letter for the hard disk drive HDD2, sdb, precedes that of the corresponding drive letter for the hard disk drive HDD1, sdc.

However, in the above case, drive letter drift may occur, bringing about great uncertainty for application layer programs or application programs. As an example, after the operating system is restarted or any of the hard disk drives is electrically reconnected, the operating system may still first identify the hard disk drive HDD0 and generate sda as its corresponding drive letter. However, it may subsequently identify first the hard disk drive HDD1 and then the hard disk drive HDD2 and, accordingly, generate first sdb as the corresponding drive letter for the hard disk drive HDD1 and then sdc as the corresponding drive letter for the hard disk drive HDD2. Such changes in drive letter assignment for the hard disk drives may lead to uselessness of the previously stored files or information. Therefore, still further improvement would be desirable for the prior art.

### SUMMARY OF THE INVENTION

In view of the above problems with the prior art, including drive letter drift possibly caused by the generation of corresponding drive letters for hard disk drives in the order where they are identified, which may lead to uselessness of stored files or information, it is a primary object of the present invention to provide a drive letter binding system, which can overcome at least one of the problems with the prior art.

An essential technical feature on which the present invention relies for overcoming the problems with the prior art resides in providing a drive letter binding system for binding a plurality of hard disk drives to their respective corresponding drive letters, which includes a reading module, a binding module and an execution module. The reading module is configured to, after an operating system of a host identifies the hard disk drives and their respective corresponding drive letters, read both the drive letters and hard disk drive identification paths corresponding to the respective hard disk drives. The binding module is electrically connected to the reading module and configured to bind the hard disk drives to their respective corresponding drive letters using their respective hard disk drive identification paths and generate binding information. The execution module is electrically connected to the binding module and configured to, in the event of any of the hard disk drives being electrically reconnected to the host or the operating system being restarted after the binding information has been generated, utilize the binding information to enable the operating system to identify, based on the hard disk drive identification paths of the hard disk drives, the drive letters to which the respective hard disk drives are bound.

On the basis of the essential technical feature, an optional technical feature of the present invention is that the binding module in the drive letter binding system includes an identifying unit for identifying key words in the hard disk drive identification paths.

On the basis of the essential technical feature, an optional technical feature of the present invention is that the binding module in the drive letter binding system includes a classifying unit for classifying the hard disk drive identification paths into a plurality of categories based on the key words.

On the basis of the essential technical feature, an optional technical feature of the present invention is that the binding module in the drive letter binding system includes a sorting unit for sorting the hard disk drive identification paths in each of the categories and thereby generating the binding information.

On the basis of the essential technical feature, an optional technical feature of the present invention is that the drive letter binding system further includes a storage module, which is electrically connected to the binding module and configured to store the binding information.

Another essential technical feature on which the present invention relies for overcoming the problems with the prior art resides in providing a drive letter binding method implemented by the above drive letter binding system, which includes the steps of: the reading module reading the drive letters and hard disk drive identification paths corresponding to the respective hard disk drives; the binding module binding the hard disk drives to the respective corresponding drive letters using their respective hard disk drive identification paths and generating binding information; and in the event of electrical reconnection of any of the hard disk drives to the host or restart of the operating system after the binding information has been generated, the execution module utilizing the binding information to enable the operating system to identify, based on the hard disk drive identification paths of the hard disk drives, the drive letters to which the respective hard disk drives are bound.

On the basis of the essential technical feature, an optional technical feature of the present invention is that one of the steps of in the drive letter binding method further includes the step of identifying key words in the hard disk drive identification paths by an identifying unit in the binding module.

On the basis of the essential technical feature, an optional technical feature of the present invention is that one of the steps of in the drive letter binding method further includes the step of classifying the hard disk drive identification paths into a plurality of categories based on the key words by a classifying unit in the binding module.

On the basis of the essential technical feature, an optional technical feature of the present invention is that one of the steps of in the drive letter binding method further includes the step of sorting the hard disk drive identification paths in each of the categories and thereby generating the binding information by a sorting unit in the binding module.

On the basis of the essential technical feature, an optional technical feature of the present invention is that the drive letter binding method further includes the step of storing the binding information by a storage module.

As described above, in the drive letter binding system and method of the present invention, the reading, binding and execution modules are used to bind hard disk drives to their respective corresponding drive letters. Compared with the prior art, the present invention utilizes the reading module to read hard disk drive identification paths, the binding module to bind the hard disk drives to their respective corresponding drive letters using the respective hard disk drive identification paths and generate binding information, and finally the execution module to utilize the binding information to allow the operating system to identify the corresponding drive letters of the respective hard disk drives based on their respective hard disk drive identification paths in the event of any hard disk drive being electrically reconnected to the host or the operating system being restarted, thereby solving the problems of drive letter drift and hence the consequent uselessness of the previously stored files and information, as found in the prior art.

### BRIEF DESCRIPTION OF THE DRAWINGS

FIG. 1 is a flowchart illustrating the identification of a hard disk drive by an operating system in accordance with the prior art;

FIG. 2 is a block diagram of a drive letter binding system according to a preferred embodiment of the present invention;

FIG. 3 schematically illustrates the drive letter binding system that is being used according to a preferred embodiment of the present invention; and

FIG. 4 is a flowchart of a drive letter binding method according to a preferred embodiment of the present invention.

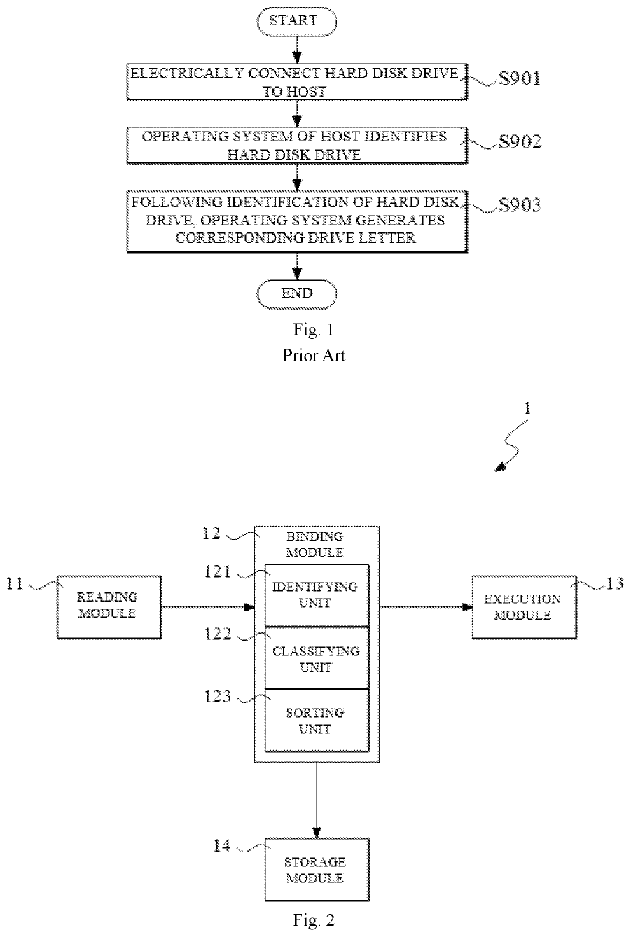

1 Drive Letter Binding System

11 Reading Module

12 Binding Module

121 Identifying Unit

122 Classifying Unit

123 Sorting Unit

13 Execution Module

14 Storage Module

2 Host

21 Operating System

H1, H2, H3 Hard Disk Drives

S101-S107, S901-S903 Steps.

### DETAILED DESCRIPTION

Specific embodiments of the present invention will be described in greater detail below with reference to the accompanying schematic drawings. Advantages and features of the present invention will become more apparent from the following description and from the appended claims. Note that the figures are provided in a very simplified form not necessarily drawn to exact scale and for the only purpose of facilitating easy and clear description of the disclosed embodiments.

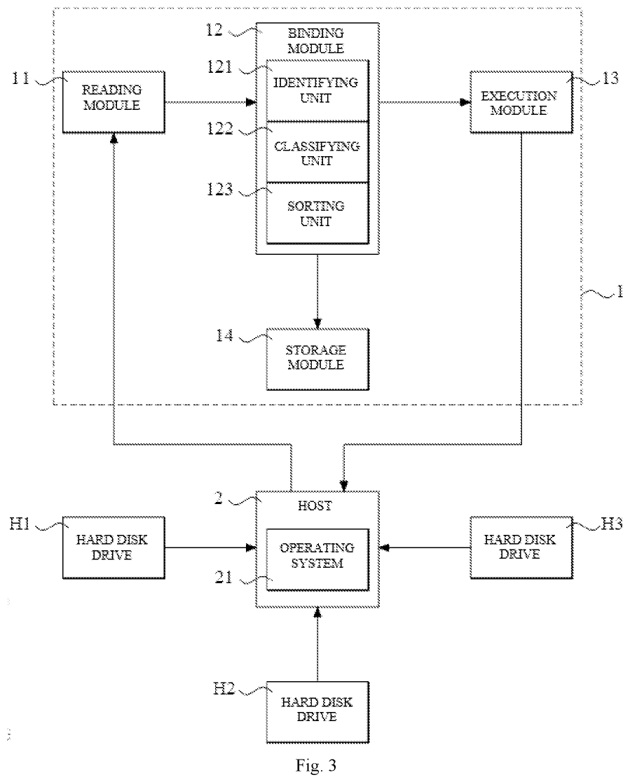

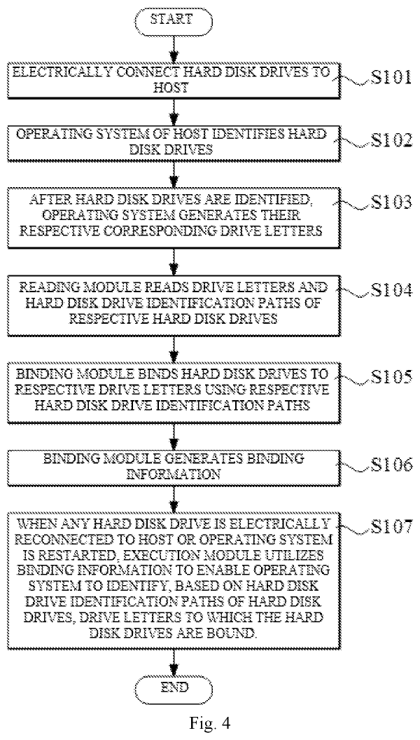

Reference is made to FIG. 2, a block diagram of a drive letter binding system according to a preferred embodiment of the present invention, and to FIG. 3, a schematic illustration of the drive letter binding system that is being used in accordance with a preferred embodiment of the present invention. As shown, the drive letter binding system 1 is an operating system 21, which is electrically connected to a host 2 and includes a reading module 11, a binding module 12 and an execution module 13. A plurality of (three are shown as an example) hard disk drives H1, H2, H3 are electrically connected to the host 2.

After identifying the hard disk drives H1, H2, H3, the operating system 21 will generate corresponding drive letters, for example, sda for the hard disk drive H1, sdb for the hard disk drive H2 and sdc for the hard disk drive H3.

Reference can be made to Tables 3 and 4 below. Table 3 shows the order of electrical connection of the hard disk drives to the host, and Table 4 presents the drive letters generated by the operating system.

TABLE 3
Hard Disk Drive H1
Hard Disk Drive H2
Hard Disk Drive H3

TABLE 4
sda
sdb
sdc

The reading module 11 is adapted to, after the operating system 21 has identified the hard disk drives H1, H2, H3 and generated the drive letters, read both the drive letters and hard disk drive identification paths associated with the respective hard disk drives H1, H2, H3. The hard disk drive identification paths (ID_PATH) are environment variables in the form of unique identifiers in the operating system 21, which can be used to distinguish the different devices (hard disk drives). Therefore, the influence of restart of the operating system 21 or removal, reconnection or replacement of any of the hard disk drive can be avoided.

The binding module 12 is electrically connected to the reading module 11 and is adapted to bind the hard disk drives H1, H2, H3 to the respective corresponding drive letters using the respective hard disk drive identification paths and produce binding information.

In this embodiment, the binding module 12 further includes an identifying unit 121, a classifying unit 122 and a sorting unit 123.

The identifying unit 121 is operable to identify the hard disk drive identification paths of the hard disk drives H1, H2, H3, as well as predefined key words therein. The hard disk drive identification paths may vary with the locations where the hard disk drives H1, H2, H3 are electrically connected to the host 2. In this embodiment, the hard disk drive identification path of any hard disk drive may contain the key word “ata” if the specific hard disk drive is electrically connected to a platform controller hub (PCH) and a central processing unit (CPU), or the key word “scsi” if the specific hard disk drive is electrically connected to redundant arrays of inexpensive disks (RAID) or an expander thereof (RAID+Expander), or the key word “sas-0x” if the specific hard disk drive is electrically connected to a host bus adapter (HBA), or the key word “sas-exp” if the specific hard disk drive is electrically connected to an expander of the host bus adapter (HBA+Expander).

The classifying unit 122 is operable to classify the hard disk drive identification paths into predefined categories based on the predefined key words therein. For example, when the identifying unit 121 identifies the key word “ata” in the hard disk drive identification path of the hard disk drive H1, it may classify the hard disk drive H1 into a first category as a hard disk drive electrically connected to the PCH and CPU. When the identifying unit 121 identifies the key word “scsi” in a hard disk drive identification path, it may classify it into a second category as a hard disk drive electrically connected to the RAID or RAID+Expander. Likewise, classification into a third category for the key word “sas-0x” and a fourth category for “sas-exp” may occur.

The sorting unit 123 is operable to sort the hard disk drive identification paths in each category. As an example, the hard disk drive identification paths “sas-exp0x-phy2” and “sas-exp0x-phy1” of the hard disk drives H2 and H3 may be sorted by the sorting unit 123 as shown in Table 5 below.

TABLE 5

| | Hard disk | Hard Disk Drive | |
|---|---|---|---|
| Rank | drive | Identification Path | Drive Letter |
| 1 | H3 | sas-exp0x-phy1 | sdc |
| 2 | H2 | sas-exp0x-phy2 | sdb |

Accordingly, the binding module 12 produces the binding information, for example, as shown in Table 6 below.

TABLE 6

| | | | |
|---|---|---|---|
| | Hard disk | Hard disk drive | |
| Rank | drive | identification path | Drive letter |

First Category

| | | | |
|---|---|---|---|
| 1 | H1 | ata-1 | sda |

Second category
Third category
Fourth category

| | | | |
|---|---|---|---|
| 1 | H3 | sas-exp0x-phy1 | sdc |
| 2 | H2 | sas-exp0x-phy2 | sdb |

Table 6 is merely an example of the binding information, and it should be understood how the binding module 12 is implemented from the above teachings. Although there is no hard disk drive in both the second and third categories in the example of Table 6, from the above teachings, it should be understood how the binding information in Table 6 will vary if one or more hard disk drives in the second category and/or the third category are identified.

The execution module 13 is electrically connected to the binding module 12 and the operating system 21 and is configured to, in the event of electrical reconnection of any of the hard disk drives H1, H2, H3 to the host or restart of the operating system 21 after the binding information has been generated by the binding module 12, utilize the binding information to enable the operating system 21 to identify, based on the hard disk drive identification paths of the hard disk drives H1, H2, H3, the drive letters to which the respective hard disk drives H1, H2, H3 are bound.

In this embodiment, the drive letter binding system 1 further includes a storage module 14, which is electrically connected to the binding module 12 and configured to store the binding information.

Thus, the drive letter binding system 1 can bind the hard disk drives H1, H2, H3 to their respective corresponding drive letters, without the problems of drive letter drift and hence the consequent uselessness of the stored files and information, as found in the prior art, even when any of the hard disk drives H1, H2, H3 is electrically reconnected to the host 2 or the operating system 21 is restarted.

Reference is now made to FIGS. 2 to 4. FIG. 4 is a flowchart of a drive letter binding method according to a preferred embodiment of the present invention. As shown, the drive letter binding method is implemented by the drive letter binding system 1 and includes steps S101 to S107 below.

In step S101, hard disk drives are electrically connected to a host.

In step S102, an operating system of the host identifies the hard disk drives.

In step S103, after the hard disk drives are identified, the operating system generates their respective corresponding drive letters.

Steps S101 to S103 are the same as steps S901 to S903 in the prior-art method and, therefore, need not be described in further detail herein.

In step S104, the reading module reads the drive letters and the hard disk drive identification paths of the respective hard disk drives.

The reading module 11 is configured to, after the operating system 21 identifies the hard disk drives H1, H2, H3 and generates their respective drive letters, read the drive letters and the hard disk drive identification paths of the respective hard disk drives H1, H2, H3.

In step S105, the binding module binds the hard disk drives to the respective drive letters using their respective hard disk drive identification paths.

The binding module 12 is configured to bind the hard disk drives H1, H2, H3 to the respective corresponding drive letters using their respective hard disk drive identification paths.

In step S106, the binding module generates binding information.

In step S106, the binding module 12 may further include the identifying unit 121, the classifying unit 122 and the sorting unit 123.

The identifying unit 121 is operable to identify the hard disk drive identification paths of the hard disk drives H1, H2, H3 and predefined key words in the hard disk drive identification paths. The classifying unit 122 is operable to classify the hard disk drive identification paths into predefined categories based on the predefined key words. The sorting unit 123 is operable to sort the hard disk drive identification paths in each category. Thus, the binding module 12 can generate the binding information.

In step S107, in the event of any hard disk drive being electrically reconnected to the host or the operating system being restarted, the execution module utilizes the binding information to enable the operating system to identify the drive letters to which the respective hard disk drives are bound, based on the hard disk drive identification paths of the hard disk drives.

The execution module 13 is electrically connected to the binding module 12 and the operating system 21 and is configured to, in the event of electrical reconnection of any of the hard disk drives H1, H2, H3 to the host or restart of the operating system 21 after the binding information has been generated by the binding module 12, utilize the binding information to enable the operating system 21 to identify, based on the hard disk drive identification paths of the hard disk drives H1, H2, H3, the drive letters to which the respective hard disk drives H1, H2, H3 are bound.

In summary, in the drive letter binding system and method of the present invention, the reading, binding and execution modules are used to bind hard disk drives to their respective corresponding drive letters. Compared with the prior art, the present invention utilizes the reading module to read hard disk drive identification paths, the binding module to bind the hard disk drives to their respective corresponding drive letters using the respective hard disk drive identification paths and generate binding information, and finally the execution module to utilize the binding information to allow the operating system to identify the corresponding drive letters of the respective hard disk drives based on their respective hard disk drive identification paths in the event of any hard disk drive being electrically reconnected to the host or the operating system being restarted, thereby solving the problems of drive letter drift and hence the consequent uselessness of the previously stored files and information, as found in the prior art.

With the detailed description of the above preferred embodiments, it is intended to more clearly describe the features and spirit of the present invention without limiting the scope thereof. Rather, it is intended that various modifications and equivalent arrangements are all embraced within the scope of the invention sought to be protected by this application.

What is claimed is:

1. A drive letter binding system for binding a plurality of hard disk drives to a plurality of drive letters corresponding to the plurality of hard disk drives, the drive letter binding system comprising:
a reading module configured to, after an operating system of a host identifies the plurality of hard disk drives and the plurality of drive letters corresponding to the plurality of hard disk drives, read both the plurality of drive letters and hard disk drive identification paths corresponding to the respective hard disk drives;
a binding module electrically connected to the reading module, the binding module configured to bind each hard disk drive to a corresponding one of the drive letters using the hard disk drive identification paths of the hard disk drives and generate binding information; and
an execution module electrically connected to the binding module, the execution module configured to, in the event of electrical reconnection of any of the hard disk drives to the host or restart of the operating system after the binding information has been generated, utilize the binding information to enable the operating system to identify, based on the hard disk drive identification paths of the hard disk drives, the drive letters to which the respective hard disk drives are bound.

2. The drive letter binding system of claim 1, wherein the binding module comprises an identifying unit for identifying key words in the hard disk drive identification paths.

3. The drive letter binding system of claim 2, wherein the binding module comprises a classifying unit for classifying the hard disk drive identification paths into a plurality of categories based on the key words.

4. The drive letter binding system of claim 3, wherein the binding module comprises a sorting unit for sorting the hard disk drive identification paths in each of the categories and thereby generating the binding information.

5. The drive letter binding system of claim 1, further comprising a storage module, which is electrically connected to the binding module and configured to store the binding information.

6. A drive letter binding method implemented by the drive letter binding system of claim 1, the drive letter binding method comprising the steps of:
a) the reading module reading the plurality of drive letters and hard disk drive identification paths corresponding to the respective hard disk drives;
b) the binding module binding each hard disk drive to a corresponding one of the drive letters using the hard disk drive identification paths of the hard disk drives and generating binding information; and
c) in the event of electrical reconnection of any of the hard disk drives to the host or restart of the operating system after the binding information has been generated, the execution module utilizing the binding information to enable the operating system to identify, based on the hard disk drive identification paths of the hard disk drives, the drive letters to which the respective hard disk drives are bound.

7. The drive letter binding method of claim 6, wherein step b) further comprises the step of:
b1) identifying key words in the hard disk drive identification paths by an identifying unit in the binding module.

8. The drive letter binding method of claim 7, wherein step b) further comprises the step of:
b2) classifying the hard disk drive identification paths into a plurality of categories based on the key words by a classifying unit in the binding module.

9. The drive letter binding method of claim 8, wherein step b) further comprises the step of:
b3) sorting the hard disk drive identification paths in each of the categories and thereby generating the binding information by a sorting unit in the binding module.

10. The drive letter binding method of claim 6, further comprising the step of:
d) storing the binding information by a storage module.
